(19) United States
(12) Patent Application Publication
(10) Pub. No.: US 2026/0017813 A1
(43) Pub. Date: Jan. 15, 2026

(54) SYSTEM AND METHOD FOR GENERATING CUSTOM MOBILITY EQUIPMENT

(71) Applicant: United Seating & Mobility, LLC, Brentwood, TN (US)

(72) Inventors: Elizabeth Floegel, Brentwood, TN (US); Bret Barczak, Brentwood, TN (US); Justin Peterfish, Brentwood, TN (US); Jose Negron, Brentwood, TN (US); John Pryles, Brentwood, TN (US)

(21) Appl. No.: 18/770,032

(22) Filed: Jul. 11, 2024

(51) Int. Cl. G06T 7/60; A61G 5/00; G06T 7/70; G06T 17/00

(52) U.S. Cl. CPC G06T 7/60; A61G 5/00; G06T 7/70; G06T 17/00

(57) ABSTRACT

Systems, methods, and computer-readable storage media for generating custom mobility equipment, and more specifically to using pictures of an individual to generate custom measurements which can be used to create custom-fit wheelchairs, crutches, and other mobility equipment. The system can receive images, the images capturing a human being, then estimate (based on the images) at least one pose of the human being. Based on that at least one pose, the system can identify that the human being needs mobility equipment (e.g., a wheelchair, crutches, etc.). The system can also identify at least one reference object within the images and generate, using the images and the at least one pose of the human being, a three-dimensional (3D) model of the human being. The system can then calculate, using the 3D model and the at least one reference object, real-world distances between predefined points of interest on the human being.

### BACKGROUND

### 1. Technical Field

The present disclosure relates to generating custom mobility equipment, and more specifically to using pictures of an individual to generate custom measurements which can be used to create custom-fit wheelchairs, crutches, and other mobility equipment.

### 2. Introduction

Individuals that require wheelchairs, crutches, and other mobility equipment are often given a ‘generic’ item that can be used by anyone. While such solutions may be viable for short-term use, individuals that require long-term mobility equipment will have greater comfort by using mobility equipment tailored for that individual's dimensions and need.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a plurality of images, the plurality of images capturing a human being; estimating, via at least one processor of the computer system based on the plurality of images, at least one pose of the human being; identifying, via the at least one processor based on the at least one pose, that the human being needs mobility equipment; identifying, via the at least one processor, at least one reference object within the plurality of images; generating, via the at least one processor using the plurality of images and the at least one pose of the human being, a three-dimensional (3D) model of the human being; and calculating, via the at least one processor using the 3D model and the at least one reference object, real-world distances between predefined points of interest on the human being.

A system configured to perform the concepts disclosed herein can include: at least one processor; and a non-transitory computer-readable storage medium having instructions stored which, when executed by the at least one processor, cause the at least one processor to perform operations comprising: receiving a plurality of images, the plurality of images capturing a human being; estimating, based on the plurality of images, at least one pose of the human being; identifying, based on the at least one pose, that the human being needs mobility equipment; identifying at least one reference object within the plurality of images; generating, using the plurality of images and the at least one pose of the human being, a three-dimensional (3D) model of the human being; and calculating, using the 3D model and the at least one reference object, real-world distances between predefined points of interest on the human being.

A non-transitory computer-readable storage medium configured as disclosed herein can have instructions stored which, when executed by at least one processor, cause the at least one processor to perform operations which include: receiving a plurality of images, the plurality of images capturing a human being; estimating, based on the plurality of images, at least one pose of the human being; identifying, based on the at least one pose, that the human being needs mobility equipment; identifying at least one reference object within the plurality of images; generating, using the plurality of images and the at least one pose of the human being, a three-dimensional (3D) model of the human being; and calculating, using the 3D model and the at least one reference object, real-world distances between predefined points of interest on the human being.

### BRIEF DESCRIPTION OF THE DRAWINGS

FIG. 1 illustrates an example flow diagram showing the generation of a custom wheelchair;

FIG. 2 illustrates an example system;

FIG. 3 illustrates an example of a virtual machine's interactions within the system;

FIG. 4 illustrates an example of a Graphics Processing Unit (GPU) virtual machine within the system;

FIG. 5 illustrates an example method embodiment; and

FIG. 6 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Today, wheelchair and mobility device fittings are done via manual tape measures and paper forms. Systems configured as disclosed herein utilize mobile device images (e.g., photographs taken using smart phones or other computing devices), connected to machine learning computer systems, to automate the measurement process. In some configurations, these measurements can then be used to order or otherwise generate tailored mobility equipment in an automated manner.

The problem presented by manual tape measurements is that these measurements are complicated due to the inconsistent nature of posture and comorbidities of wheelchair users. Manual tape introduces inconsistencies, is slow, and may require a level of expertise in working with mobility-challenged individuals to obtain usable measurements. By contrast, systems configured as disclosed herein can generate accurate and consistent measurements every time, regardless of body and posture differences, thereby providing improved accuracy and faster measurements. Moreover, the system is designed such that it can increase in accuracy of over time. The data generated by images can allow for additional analysis on real world outcomes of usage of specific devices, predictive measurements, and can allow for wheelchair users to have improved fitting which leads to better overall health.

In addition, systems configured as disclosed herein allow for production of measurements of individuals while they are in a sitting or prone position. The system disclosed herein reduces manufacturing and productivity waste generated when human error fits a device incorrectly, which not only delays the receipt of the device to the end user, but wastes energy in the manufacturing, delivery, and human effort to assemble an inaccurate device.

Consider the following example. A user takes their smartphone and they take several pictures of an individual that needs a wheelchair. The user then sends those pictures to the system, which renders a three dimensional (3D) model of the individual. The system can also receive information identifying the individual's need (in this case a wheelchair). Based on that 3D model and the specific need, the system can generate measurements between specific points of the individual. In this example, those specific points could be: (A) between the individual's knee and hip (for the base of the chair), (B) between the hip and the shoulder (for the back of the chair), and (C) from the knee to the foot (to know at what height the chair should sit). Depending on the configuration, the system can then send the measurements back to the user or send the measurements directly to a manufacturer of the mobility equipment needed.

In some configurations, rather than requiring that the individual's mobility equipment need be provided, the system can receive the photographs of the individual and produce a 3D model which can be used for many different types of mobility equipment. For example, the system may receive the photographs, then generate the 3D model of the individual. Then, the user of the system can submit a request for measurements associated with use of a cane while the user is standing or walking, and the system can (using the 3D model) generate those measurements. Likewise, if the user wished to request both a cane and a wheelchair, the same model can be used to generate both measurements.

Non-limiting examples of mobility equipment for which the system disclosed herein can be used to generate measurements can include: wheelchairs, a crutch (or crutches), a scooter, a walker, a transport chair, an orthotic device, a cane (or canes), and a rollator. In instances where measurements may vary between the left and right sides of the body (i.e., on different sides of the lateral or sagittal plane), the 3D model can be used to generate mobility equipment for a specific side, thereby accounting for any differences in bilateral symmetry.

In some configurations, the system can then receive feedback from the individual once the tailored mobility equipment is delivered. This feedback can then be used by a machine learning algorithm or Artificial Intelligence (AI) algorithm which can modify how the 3D model and/or measurements are generated. For example, upon receiving feedback from multiple individuals indicating that their tailored wheelchairs sit too close to the ground, the system, via the AI algorithm, can change how the measurements are generated such that future measurements generated by the system add additional space. More specifically, the system can modify how the 3D model results in tailored measurements for mobility devices by adjusting the measurements according to some percentage of the total length of a particular measurement, or based upon a total value, depending upon the feedback received and the original measurements provided. In this manner the system can become more accurate over time. The feedback received by the system from individuals/users can, for example, be of a positive/negative feedback format (e.g., the mobility equipment designed by the system fits great/does not fit right; a binary feedback), or can be numerical (e.g., the mobility equipment is too long by x amount, too short by x amount, too small by x amount, etc., where x represents a distance value).

The system disclosed herein can be a combination of one or more virtual machines, each of which can execute processing algorithms (such as, but not limited to, algorithms which identify body parts, body pose(s), missing limbs/body parts, etc.), generation of the 3D model, and/or generating measurements between measurement points based on the 3D model. In some configurations, the system can include the computing device (e.g., a cell phone, smartphone, tablet computer, laptop computer, etc.) which takes the initial photographs of the individual in need of a mobility device, with the portion of the system processing the photographs, building the 3D model, and generating the measurements are part of a cloud computing service using one or more servers or similar computing devices.

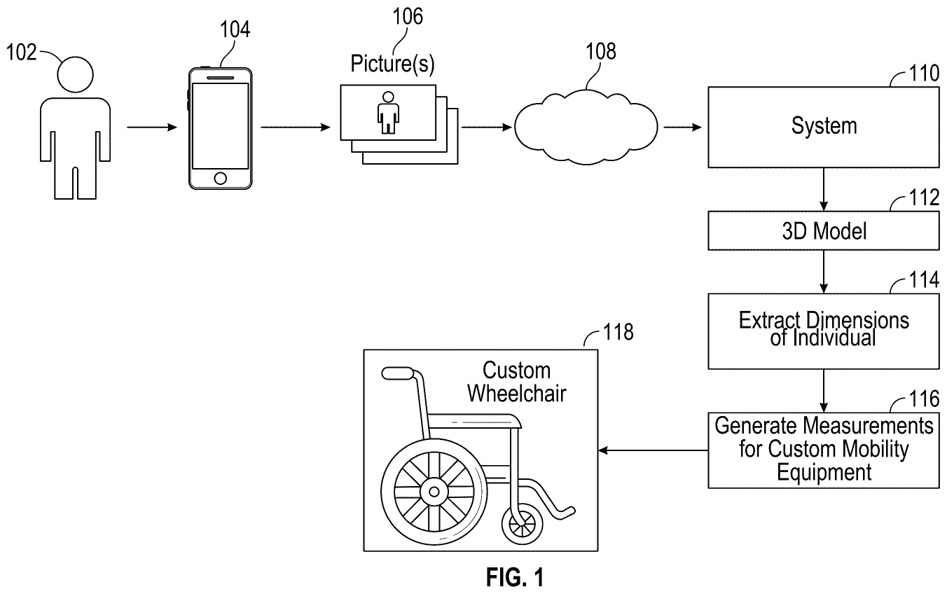

FIG. 1 illustrates an example flow diagram showing the generation of a custom wheelchair. In this example, an individual 102 is in need of a tailored wheelchair, and multiple pictures 106 of the individual 102 are taken using a cellphone 104. The pictures 106 are transmitted across a network 108 (e.g., the Internet) to a system 110, which builds a 3D model 112 of the individual. Based on that 3D model, the system 110 can extract dimensions 114 of the user individual 102. For example, given that the individual 102 is looking for a wheelchair, the system may want to determine the length of the individual's femur, tibia, back, etc., from the 3D model. Based on these dimensions of the individual 102, the system generates measurements 116 for custom mobility equipment. These measurements 116 can then be used to build a custom wheelchair 118. That is, based on the dimensions of the individual 102, the system 110 can generate ideal measurements for custom wheelchair 118.

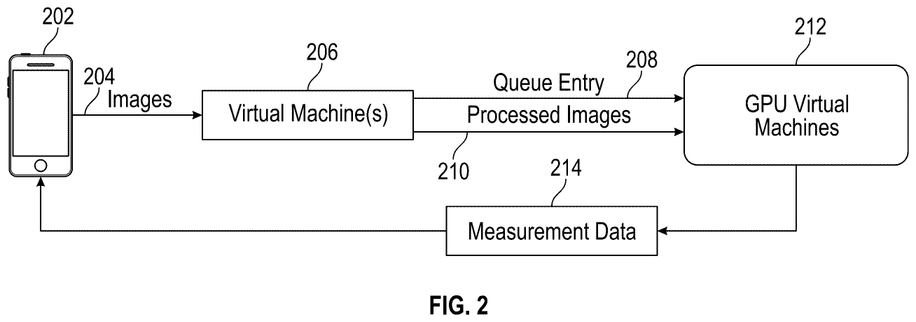

FIG. 2 illustrates an example system. In this example, a cellphone 202 transmits images 204 to one or more virtual machine(s) 206, which generate a queue entry for the job associated with the images 204, and send the queue entry 208 and processed images 210 to one or more Graphics Processing Unit (GPU) Virtual Machine(s) (or other type of virtual machine capable of building and processing a 3D model as disclosed herein). The GPU Virtual machine(s) build a 3D model of an individual based on the images and generate measurement data 214 which is sent back to the cellphone 202. The user of the cellphone 202 can then order custom tailored mobility equipment using the measurement data 214. In alternative configurations, the measurement data 214 is sent directly to a manufacturing entity, along with the type of mobility equipment needed, which is then used by the manufacturing entity to build the tailored mobility equipment. In yet another alternative configuration, that manufacturing entity can be part of the system, such that the system, upon receiving the images 204 and a type of mobility equipment needed, automatically uses the measurement data 214 to build the tailored mobility equipment.

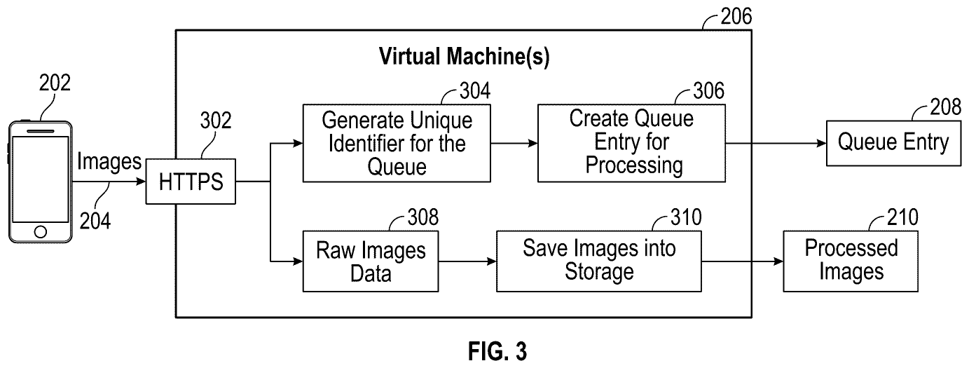

FIG. 3 illustrates an example of a virtual machine's 206 interactions within the system. That is, FIG. 3 shows at least some of the internal workings of the virtual machine(s) 206 illustrated in FIG. 2. As illustrated, the images 204 are received at the virtual machine(s) 206 via a Hypertext Transfer Protocol Secure (HTTPS) 302, allowing secure/encrypted communication over a computer network such as the Internet from the cellphone 202 to the Virtual Machine(s) 206. In some configurations, a non-secure communication (e.g., HTTP) path may be used. As illustrated, upon receiving the images, the system generates a unique identifier for a queue 304, and creates a queue entry 306 for processing the images 204. The Virtual Machine(s) 206 also (in parallel, or in series, with the generating of the unique identifier for a queue 304 and the queue entry 306) receive the raw images data 308 (that is, the pixel information from the images 204), and save that raw images data 308 to storage 310. These now processed images 210 are then transmitted/forwarded to the GPU Virtual Machine(s) 212 with the Queue Entry 208 as illustrated in FIG. 2.

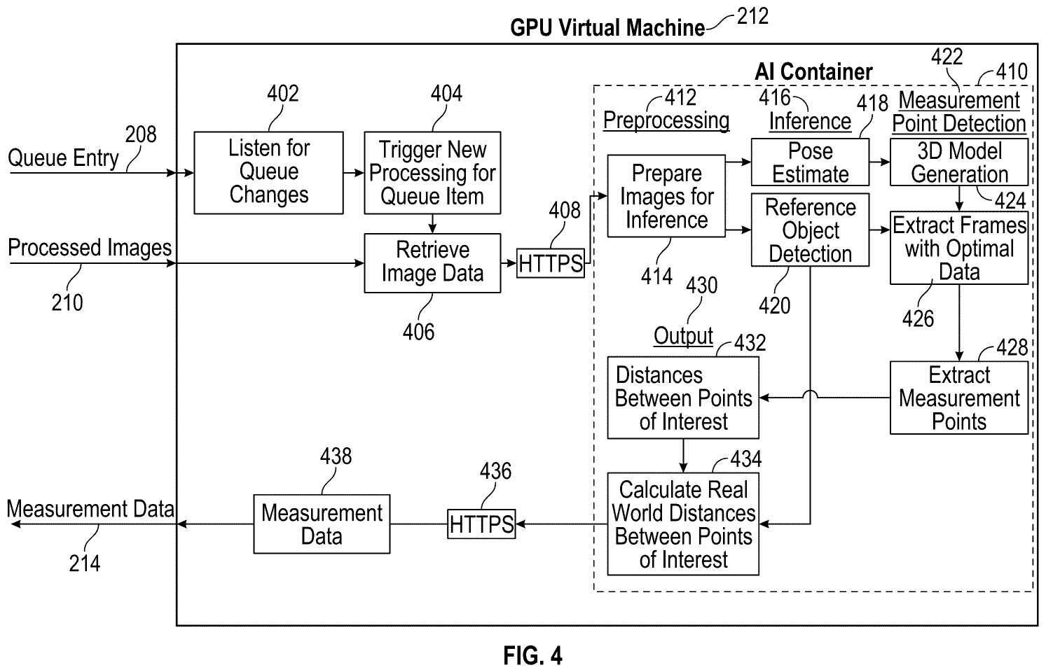

FIG. 4 illustrates an example of the Graphics Processing Unit (GPU) virtual machine 212 within the system. As illustrated, the GPU Virtual Machine 212 receives the queue entry 208 and processed images 210, as illustrated in both FIG. 2 and FIG. 3. The GPU Virtual Machine 212 can constantly be checking (e.g., listening) for changes to the queue 402. Upon receiving the queue entry 208, the GPU Virtual Machine 212 can trigger 404 new processing for the queue item, beginning with the retrieval of the image data 406 from the processed images 210. In configurations where the processed images 210 were saved to a specific storage location, this can mean sending a request for those images and receiving them in response. Alternatively, if the image data itself is contained within the processed images 210 received, retrieving the image data 406 may mean saving (within the GPU Virtual Machine 212) the image data.

The image data is then sent, using a HTTPS 408 connection, the image data (and/or queue data) to an Artificial Intelligence (AI) container 410 (e.g., an instance on AMAZON WEB SERVICES (AWS), AZURE, or other cloud computing service with AI services). The AI container 410 then performs preprocessing 412 of the image data, preparing the images 210 for inference 414. The AI container 410 then performs Inference 416, generating a pose estimate 418 and/or performing reference object detection 420. The purpose of the pose estimation 418 is to identify how the individual in the images is standing/sitting/laying/otherwise posing. This can be done, for example, by identifying specific portions of the individual's body in the images (e.g., this picture illustrates the individual's head and arm, the next picture illustrates the torso and two arms, etc.), determining the spatial relationship of those identified portions of the individual's body to one another, and comparing the identified relationships to known relationships of predetermined poses. The reference object detection is to provide a scale for the images, allowing the system to have a baseline unit of measurements within the images. While the reference object can be any predetermined image, text, or other object within known dimensions, in practice using a Quick Reference (QR) code with predetermined spatial dimensions can be a useful reference object.

The GPU Virtual Machine 212 then executes measurement point detection 422, generating a 3D model 424 based on the pose estimate 418 data and/or the images. Using the generated 3D model and the reference object, the system then identifies the frames (e.g., images) and/or aspects of the 3D model which have optimal data 426. This determination can, for example, be based on the clearest view of the individual's body portions which are critical for the type of mobility device in question, based on the clearest view of the reference object, and/or based on a combination of multiple images/photographs, such that the 3D model covering those portions has increased accuracy. The AI container 410 then, as part of the Output 430 process, calculates measurement points 428 (i.e., the different points (such as the elbows, knees, hip, shoulders, etc.) of the individual within the model), and calculates the distances 432 between points of interest within the model. Based on the distances 432 between points of interest, the AI container calculates real world distances between points of interest 434. Preferably, these distances are based on the reference object, with the distances of points within the model being directly associated with distances in the real world. The system then outputs the real world measurements (through another HTTPS connection 436) as measurement data 438, which is output back to the mobile device which captured the images as measurement data 214, illustrated in FIG. 2.

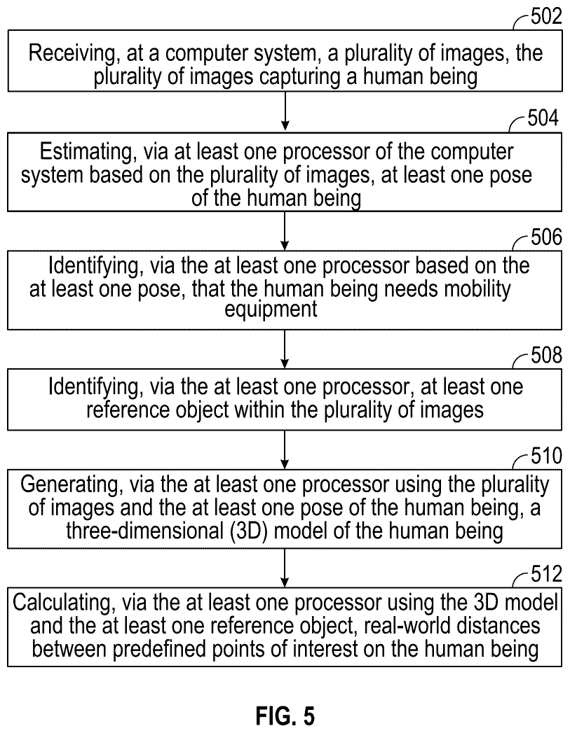

FIG. 5 illustrates an example method embodiment. As illustrated, a system configured as disclosed herein can receive a plurality of images, the plurality of images capturing a human being (502), then estimate, via at least one processor based on the plurality of images, at least one pose of the human being (504). The system can then identify, based on the at least one pose, that the human being needs mobility equipment (506) (e.g., that the human being needs a wheelchair, crutches, etc.). The system can then identify, via the at least one processor, at least one reference object within the plurality of images (508), and generate, via the at least one processor using the plurality of images and the at least one pose of the human being, a three-dimensional (3D) model of the human being (510). The system can then calculate, via the at least one processor using the 3D model and the at least one reference object, real-world distances between predefined points of interest on the human being (512).

In some configurations, the plurality of images are received from a mobile device, the mobile device comprising a camara which captured the plurality of images, and the illustrated method can further include transmitting the real-world distances from the computer system to the mobile device.

In some configurations, the illustrated method can further include generating, based on the real-world distances, a mobility device tailored to the human being. In such configurations, non-limiting examples of the mobility device can include one or more of a wheelchair, a crutch, a scooter, a walker, a transport chair, an orthotic device, a cane, and a rollator.

In some configurations, the at least one reference object comprises a Quick Response (QR) code.

In some configurations, the predefined points of interest are one of a plurality of stored sets of predefined points of interest, each stored set of predefined points of interest associated with a different type of mobility device.

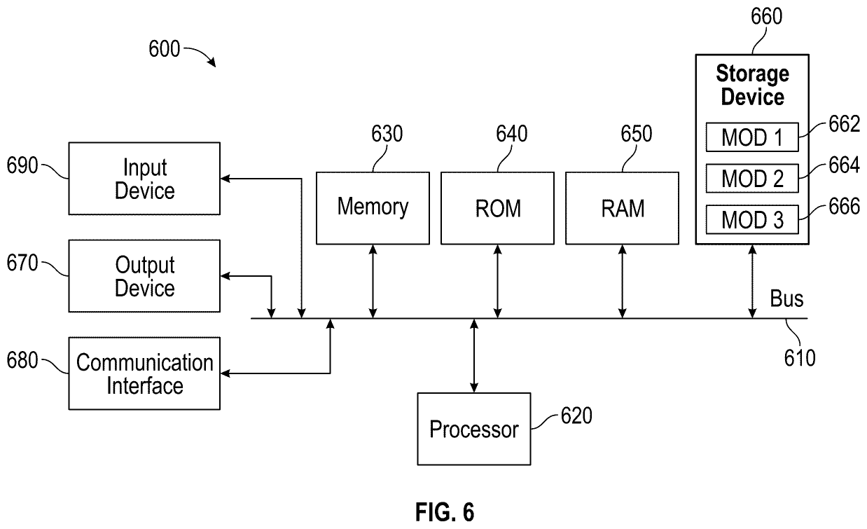

With reference to FIG. 6, an exemplary system includes a computing device 600 (such as a general-purpose computing device), including a processing unit (CPU or processor) 620 and a system bus 610 that couples various system components including the system memory 630 such as read-only memory (ROM) 640 and random access memory (RAM) 650 to the processor 620. The computing device 600 can include a cache of high-speed memory connected directly with, in close proximity to, or integrated as part of the processor 620. The computing device 600 copies data from the system memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The system memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general-purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in memory ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, system bus 610, output device 670 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 600 is a small, handheld computing device, a desktop computer, or a computer server.

Although the exemplary embodiment described herein employs the storage device 660 (such as a hard disk), other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, a plurality of images, the plurality of images capturing a human being; estimating, via at least one processor of the computer system based on the plurality of images, at least one pose of the human being; identifying, via the at least one processor based on the at least one pose, that the human being needs mobility equipment; identifying, via the at least one processor, at least one reference object within the plurality of images; generating, via the at least one processor using the plurality of images and the at least one pose of the human being, a three-dimensional (3D) model of the human being; and calculating, via the at least one processor using the 3D model and the at least one reference object, real-world distances between predefined points of interest on the human being.

The method of any preceding clause, wherein the plurality of images are received from a mobile device, the mobile device comprising a camara which captured the plurality of images; and wherein the method further comprises: transmitting the real-world distances from the computer system to the mobile device.

The method of any preceding clause, further comprising: generating, based on the real-world distances, a mobility device tailored to the human being.

The method of any preceding clause, wherein the mobility device is a wheelchair.

The method of any preceding clause, wherein the mobility device comprises one of: a crutch, a scooter, a walker, a transport chair, an orthotic device, a cane, and a rollator.

The method of any preceding clause, wherein the at least one reference object comprises a Quick Response (QR) code.

The method of any preceding clause, wherein the predefined points of interest are one of a plurality of stored sets of predefined points of interest, each stored set of predefined points of interest associated with a different type of mobility device.

A system comprising: at least one processor; and a non-transitory computer-readable storage medium having instructions stored which, when executed by the at least one processor, cause the at least one processor to perform operations comprising: receiving a plurality of images, the plurality of images capturing a human being; estimating, based on the plurality of images, at least one pose of the human being; identifying, based on the at least one pose, that the human being needs mobility equipment; identifying at least one reference object within the plurality of images; generating, using the plurality of images and the at least one pose of the human being, a three-dimensional (3D) model of the human being; and calculating, using the 3D model and the at least one reference object, real-world distances between predefined points of interest on the human being.

The system of any preceding clause, wherein the plurality of images are received from a mobile device, the mobile device comprising a camara which captured the plurality of images; and the non-transitory computer-readable storage medium having additional instructions stored which, when executed by the at least one processor, cause the at least one processor to perform operations comprising: transmitting the real-world distances from the system to the mobile device.

The system of any preceding clause, the non-transitory computer-readable storage medium having additional instructions stored which, when executed by the at least one processor, cause the at least one processor to perform operations comprising: generating, based on the real-world distances, a mobility device tailored to the human being.

The system of any preceding clause, wherein the mobility device is a wheelchair.

The system of any preceding clause, wherein the mobility device comprises one of: a crutch, a scooter, a walker, a transport chair, an orthotic device, a cane, and a rollator.

The system of any preceding clause, wherein the at least one reference object comprises a Quick Response (QR) code.

The system of any preceding clause, wherein the predefined points of interest are one of a plurality of stored sets of predefined points of interest, each stored set of predefined points of interest associated with a different type of mobility device.

A non-transitory computer-readable storage medium having instructions stored which, when executed by at least one processor, cause the at least one processor to perform operations comprising: receiving a plurality of images, the plurality of images capturing a human being; estimating, based on the plurality of images, at least one pose of the human being; identifying, based on the at least one pose, that the human being needs mobility equipment; identifying at least one reference object within the plurality of images; generating, using the plurality of images and the at least one pose of the human being, a three-dimensional (3D) model of the human being; and calculating, using the 3D model and the at least one reference object, real-world distances between predefined points of interest on the human being.

The non-transitory computer-readable storage medium of any preceding clause, wherein the plurality of images are received from a mobile device, the mobile device comprising a camara which captured the plurality of images; and the non-transitory computer-readable storage medium having additional instructions stored which, when executed by the at least one processor, cause the at least one processor to perform operations comprising: transmitting the real-world distances to the mobile device.

The non-transitory computer-readable storage medium of any preceding clause, having additional instructions stored which, when executed by the at least one processor, cause the at least one processor to perform operations comprising: generating, based on the real-world distances, a mobility device tailored to the human being.

The non-transitory computer-readable storage medium of any preceding clause, wherein the mobility device is a wheelchair.

The non-transitory computer-readable storage medium of any preceding clause, wherein the mobility device comprises one of: a crutch, a scooter, a walker, a transport chair, an orthotic device, a cane, and a rollator.

The non-transitory computer-readable storage medium of any preceding clause, wherein the at least one reference object comprises a Quick Response (QR) code.

We claim:

1. A method comprising:
receiving, at a computer system, a plurality of images, the plurality of images capturing a human being;
estimating, via at least one processor of the computer system based on the plurality of images, at least one pose of the human being;
identifying, via the at least one processor based on the at least one pose, that the human being needs mobility equipment;
identifying, via the at least one processor, at least one reference object within the plurality of images;
generating, via the at least one processor using the plurality of images and the at least one pose of the human being, a three-dimensional (3D) model of the human being; and
calculating, via the at least one processor using the 3D model and the at least one reference object, real-world distances between predefined points of interest on the human being.

2. The method of claim 1, wherein the plurality of images are received from a mobile device, the mobile device comprising a camara which captured the plurality of images; and
wherein the method further comprises:
transmitting the real-world distances from the computer system to the mobile device.

3. The method of claim 1, further comprising:
generating, based on the real-world distances, a mobility device tailored to the human being.

4. The method of claim 3, wherein the mobility device is a wheelchair.

5. The method of claim 3, wherein the mobility device comprises one of: a crutch, a scooter, a walker, a transport chair, an orthotic device, a cane, and a rollator.

6. The method of claim 1, wherein the at least one reference object comprises a Quick Response (QR) code.

7. The method of claim 1, wherein the predefined points of interest are one of a plurality of stored sets of predefined points of interest, each stored set of predefined points of interest associated with a different type of mobility device.

8. A system comprising:
at least one processor; and
a non-transitory computer-readable storage medium having instructions stored which, when executed by the at least one processor, cause the at least one processor to perform operations comprising:
receiving a plurality of images, the plurality of images capturing a human being;
estimating, based on the plurality of images, at least one pose of the human being;
identifying, based on the at least one pose, that the human being needs mobility equipment;
identifying at least one reference object within the plurality of images;
generating, using the plurality of images and the at least one pose of the human being, a three-dimensional (3D) model of the human being; and
calculating, using the 3D model and the at least one reference object, real-world distances between predefined points of interest on the human being.

9. The system of claim 8, wherein the plurality of images are received from a mobile device, the mobile device comprising a camara which captured the plurality of images; and
the non-transitory computer-readable storage medium having additional instructions stored which, when executed by the at least one processor, cause the at least one processor to perform operations comprising:
transmitting the real-world distances from the system to the mobile device.

10. The system of claim 8, the non-transitory computer-readable storage medium having additional instructions stored which, when executed by the at least one processor, cause the at least one processor to perform operations comprising:
generating, based on the real-world distances, a mobility device tailored to the human being.

11. The system of claim 10, wherein the mobility device is a wheelchair.

12. The system of claim 10, wherein the mobility device comprises one of: a crutch, a scooter, a walker, a transport chair, an orthotic device, a cane, and a rollator.

13. The system of claim 9, wherein the at least one reference object comprises a Quick Response (QR) code.

14. The system of claim 9, wherein the predefined points of interest are one of a plurality of stored sets of predefined points of interest, each stored set of predefined points of interest associated with a different type of mobility device.

15. A non-transitory computer-readable storage medium having instructions stored which, when executed by at least one processor, cause the at least one processor to perform operations comprising:
receiving a plurality of images, the plurality of images capturing a human being;
estimating, based on the plurality of images, at least one pose of the human being;
identifying, based on the at least one pose, that the human being needs mobility equipment;
identifying at least one reference object within the plurality of images;
generating, using the plurality of images and the at least one pose of the human being, a three-dimensional (3D) model of the human being; and
calculating, using the 3D model and the at least one reference object, real-world distances between predefined points of interest on the human being.

16. The non-transitory computer-readable storage medium of claim 15, wherein the plurality of images are received from a mobile device, the mobile device comprising a camara which captured the plurality of images; and
the non-transitory computer-readable storage medium having additional instructions stored which, when executed by the at least one processor, cause the at least one processor to perform operations comprising:
transmitting the real-world distances to the mobile device.

17. The non-transitory computer-readable storage medium of claim 15, having additional instructions stored which, when executed by the at least one processor, cause the at least one processor to perform operations comprising:
generating, based on the real-world distances, a mobility device tailored to the human being.

18. The non-transitory computer-readable storage medium of claim 17, wherein the mobility device is a wheelchair.

19. The non-transitory computer-readable storage medium of claim 17, wherein the mobility device comprises one of: a crutch, a scooter, a walker, a transport chair, an orthotic device, a cane, and a rollator.

20. The non-transitory computer-readable storage medium of claim 15, wherein the at least one reference object comprises a Quick Response (QR) code.
